(19) United States
(12) Patent Application Publication
(10) Pub. No.: US 2024/0219913 A1
(43) Pub. Date: Jul. 4, 2024

(54) PREDICTIVE SWITCHING BETWEEN AUTONOMOUS AND REMOTE CONTROL OF A VEHICLE

(71) Applicant: Urban Robotics, Inc., Las Vegas, NV (US)

(72) Inventor: Anand NANDAKUMAR RAGHAV, Las Vegas, NV (US)

(21) Appl. No.: 18/530,447

(22) Filed: Dec. 6, 2023

Related U.S. Application Data
(60) Provisional application No. 63/386,303, filed on Dec. 6, 2022.

(51) Int. Cl. G05D 1/227; B60W 60/00; G05D 1/222

(52) U.S. Cl. CPC G05D 1/227; B60W 60/005; G05D 1/222

(57) ABSTRACT

Predictive switching between autonomous control of a vehicle by an autonomous driving system and a remote pilot connected to the vehicle by a network. The predictive switching may include determining a route of the vehicle and identifying one or more suspect areas along the route in which the autonomous diving system is suspected of difficulty in autonomous control of the vehicle. Ahead of encountering the suspect areas, a remote driver may be assigned to the vehicle to establish communication with the vehicle and receive sensor data. This may allow for the remote pilot to monitor the vehicle including any projected autonomous operations. The remote pilot may intervene to assume control of the vehicle in the suspect area.

### BACKGROUND

Recent technological advances have presented an opportunity for new transportation solutions that may allow for operation of a vehicle autonomously. In addition, solutions have been proposed that leverage remote control of a vehicle by a remote pilot at a remote pilot terminal. The remote pilot terminal may present sensor data from a vehicle to a remote pilot such that instructions provided by the remote pilot are transmitted to and carried out at the vehicle.

Despite such recent advances, given the incredible complexity that operating a vehicle may present, there may be instances when autonomous control of a vehicle may not be accomplished. Accordingly, oftentimes autonomous systems require intervention from a local pilot to take control of the vehicle in situations in which autonomous control is not possible. As such, autonomous systems continue to be limited in applicability and versatility.

### SUMMARY

In some aspects, the techniques described herein relate to a method for switching between autonomous control and remote control of a vehicle, including: determining a route along which the vehicle is planned to travel; identifying a suspect area of the route, the suspect area including a predetermined location associated with conditions causing the autonomous control of the vehicle to be compromised; collecting sensor data from a sensor on-board the vehicle; scheduling a remote pilot for remote control of the vehicle prior to the vehicle encountering the suspect area; communicating the sensor data from the sensor on-board the vehicle to a remote pilot terminal prior to the vehicle encountering the suspect area; and receiving a control instruction from the remote pilot when the vehicle is within the suspect area.

In some aspects, the techniques described herein relate to a system for a vehicle to switching between autonomous control and remote control of the vehicle, including: a navigation system operative to determining a route along which the vehicle is planned to travel; a data repository including a plurality of suspect areas corresponding to predetermined locations including conditions causing the autonomous control of the vehicle to be compromised; a predictive system operative to compare the route to the plurality of suspect areas to identify a suspect area of the route and, in response to identifying the suspect area, schedule a remote pilot for remote control of the vehicle prior to the vehicle encountering the suspect area; at least one sensor on-board the vehicle operative to collect sensor data regarding an environment of the vehicle; and a communication interface operative to communicate the sensor data from the sensor on-board the vehicle to the remote pilot terminal prior to the vehicle encountering the suspect area and receive a control instruction from the remote pilot when the vehicle is within the suspect area.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that may be used to facilitate remote control of a vehicle.

FIG. 2 illustrates an example predictive control system.

FIG. 3 illustrates an example method for predictive switching between autonomous and remote control of a vehicle.

FIG. 4 illustrates an example schematic of a computing device suitable for implementing aspects of the disclosed technology.

### DETAILED DESCRIPTION

While the disclosure is susceptible to various modifications and alternative forms, specific embodiments thereof have been shown by way of example in the drawings and are herein described in detail. It should be understood, however, that it is not intended to limit the disclosure to the particular form disclosed, but rather, the disclosure is to cover all modifications, equivalents, and alternatives falling within the scope of the disclosure as defined by the claims.

The present disclosure generally relates to the use of a remote pilot to monitor and/or intervene in autonomous control of a vehicle. As noted above, despite advances in autonomous control of vehicles, there continue to be circumstances in which autonomous systems struggle to safely control a vehicle. For instance, highly congested areas, high pedestrian traffic areas, areas with irregular infrastructure, or other obstacles may present difficulties for autonomous systems to accurately judge a situation and generate control commands to safely guide a vehicle. Thus, while autonomous systems provide great efficiency and ease of use in many contexts, such systems are limited by requiring a local operator to remain alert and ready to intervene in situations where the autonomous system cannot safely provide commands.

In turn, the present disclosure recognizes the ability to supplement autonomous control of a vehicle using a remote pilot such that the remote pilot may assume control of a vehicle in response to an actual or anticipated scenario in which an autonomous system encounters a difficult scenario. Furthermore, the present disclosure recognizes that dedicating a remote pilot to monitor an autonomous system full time may be inefficient by requiring the remote pilot to monitor the autonomous system in situations where the autonomous system is capable of safely navigating the vehicle. In this regard, the present disclosure may provide predictive analysis to determine suspect areas in which it is suspected that the autonomous system of a vehicle may struggle to control the vehicle. In turn, a remote pilot may be assigned to monitor and/or control the vehicle through such suspect areas while allowing the autonomous system to control the vehicle in other areas that do not present difficulty to the autonomous system.

As used herein, suspect areas refer to any location, set of locations, or area that has been identified or otherwise associated with locations in which the ability of an autonomous driving system to control a vehicle is limited. As may be appreciated, an autonomous driving system may be able to successfully navigate a suspect area, however, it may be that doing so is less reliable than other areas or a specific potential hazard is identified. Thus, the suspect area may simply be associated with a predetermined location in which conditions cause autonomous control of the vehicle to be compromised or somewhat reduced. As described below, these conditions may relate to congestion (e.g., of other vehicles or pedestrians), topology (e.g., curvy or hilly areas), irregular infrastructure (e.g., irregular intersections or highly complex intersections), or even may relate to variable conditions such as weather or the like.

Such a configuration and approach to assisting autonomous systems may allow for efficient use of the time of a remote pilot. A remote pilot may be assigned to monitor and/or control a vehicle in circumstances identified as being potentially problematic for the autonomous system. Furthermore, as the remote pilot may be selectively connected to a plurality of vehicles, a given remote pilot may assist a plurality of vehicles that require remote intervention in different time periods.

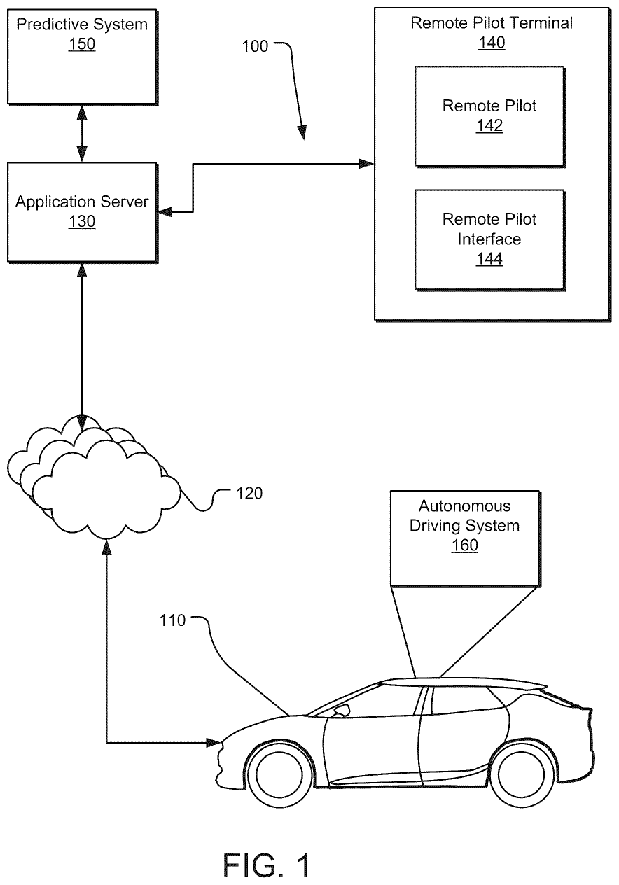

FIG. 1 illustrates an example system 100 that may be used to facilitate remote control of a vehicle 110. The vehicle 110 may be in operative connection with a remote pilot terminal 140 via a network 120. The network 120 may comprise a plurality of networks over which the vehicle 110 may communicate. Providing capability to communicate over a plurality of networks may allow for redundancy in the event of a problem with one of the networks or optimization of communication using a network 120 having the highest quality as the vehicle 110 operates through an environment.

An application server 130 may be provided that assists in orchestrating communication between the vehicle 110 and the remote pilot terminal 140. For instance, the application server 130 may coordinate connection to a remote pilot terminal 140 (e.g., when the vehicle 110 transitions from autonomous or local control to remote control). The application server 130 may also provide various assistance or aides to the vehicle 110 or the remote pilot terminal 140 to help facilitate control of the vehicle 110 by a remote pilot 142 from the remote pilot terminal 140.

The remote pilot terminal 140 may include a remote pilot interface 144. The remote pilot interface 144 may receive inputs from the remote pilot 142 for control of the vehicle 110. For example, the remote pilot interface 144 may include appropriate displays and input devices to allow the remote pilot 142 to perceive displayed sensor data from the vehicle 110 and to input control commands to the remote pilot interface 144. The remote pilot interface 144 may include any appropriate display(s) including monitors, monitor arrays, augmented reality displays, virtual reality displays, or the like. The input devices may include controls similar to those provided locally at the vehicle 110 including a steering wheel, accelerator pedal, brake pedal, drive selector, or other controls (e.g., wiper controls, headlight controls, etc.). Thus, the remote pilot 142 may be presented with an environment that mimics an interior of the vehicle 110 to help provide familiarity in remotely controlling the vehicle 110.

The vehicle 110 may also comprise an autonomous driving system 160. The autonomous driving system 160 may be operative to obtain information regarding the vehicle 110 and the surroundings of the vehicle 110 to make control decisions in relation to navigation of the vehicle 110. The autonomous driving system 160 may use the same sensors as those used for remote driving and/or unique sensors dedicated to the autonomous driving system 160. Also, while shown as being resident at the vehicle 110, components of the autonomous driving system 160 may be remote from the vehicle 110 such that operation of the autonomous driving system 160 includes exchange of information via the network 120.

The system 100 may also include a predictive system 150. The predictive system 150 may be operative to orchestrate autonomous and remote control of the vehicle 110. For instance, the predictive system 150 may receive information regarding a route of the vehicle 110. In turn, the predictive system 150 may analyze the route to determine suspect areas in which autonomous control of the vehicle 110 by the autonomous driving system 160 may be compromised. In turn, the predictive system 150 may track the vehicle 110 along the route and, ahead of encountering the suspect area identified, schedule a remote pilot 142 to be assigned to the vehicle 110. Once assigned by the predictive system 150, the remote pilot 142 may monitor operation of the vehicle 110 at the remote pilot terminal 140. This may include monitoring operation of the autonomous driving system 160 by being provided projected control operations of the autonomous driving system 160. Furthermore, the remote pilot 142 may intervene to control the vehicle 110 ahead of the vehicle 110 encountering a suspect area. This may include determining that a projected control of the autonomous driving system 160 is improper or the remote pilot 142 may simply be transferred control of the vehicle 110 from the autonomous driving system 160 ahead of a suspect area. The remote pilot 142 may operate the vehicle 110 through the suspect area and the autonomous driving system 160 may resume control over the vehicle 110 once the vehicle 110 has exited the suspect area.

While the predictive system 150 is shown as being remote from the vehicle 110, it may be appreciated that the predictive system 150 may partially or fully reside at the vehicle 110. In this regard, the predictive system 150 may be an onboard system local to the vehicle 110 or may be at least partially remote from the vehicle 110 such that the predictive system 150 communicates with the vehicle 110 via the network 120.

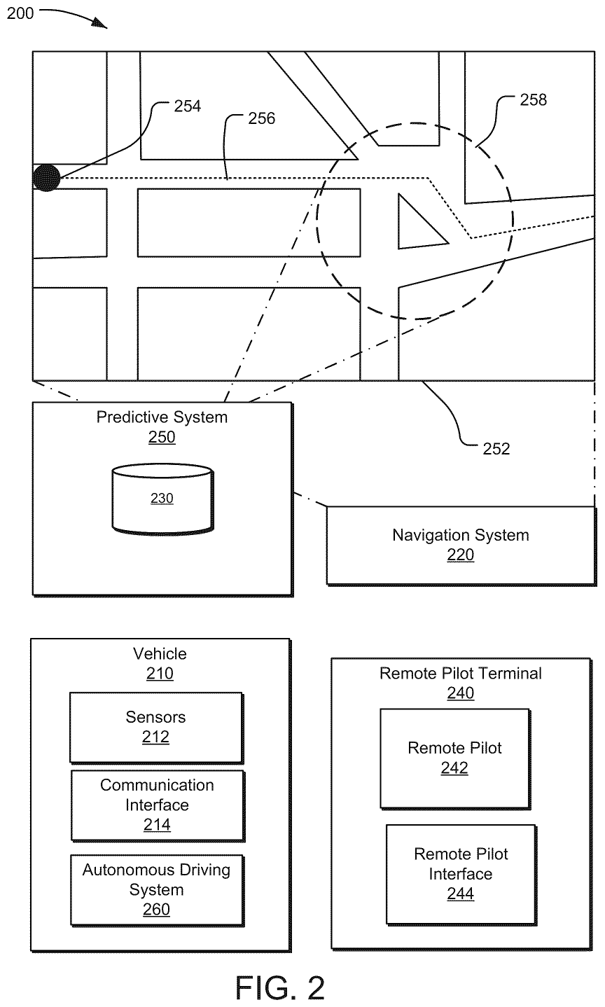

Further details of a predictive control system 200 are shown in FIG. 2. The predictive control system 200 may comprise a vehicle 210, a navigation system 220, a remote pilot terminal 240, and a predictive system 250. The vehicle 210 may be equipped with one or more sensors 212. The one or more sensors 212 may support autonomous driving and may support remote control of the vehicle. In this regard, the one or more sensors 212 may include any appropriate sensor or sensors including, for example, cameras, Lidar sensors, Radar sensors, ultrasonic sensors, or any other appropriate sensor utilized in autonomous or remote driving.

The vehicle 210 also includes a communication interface 214. The communication interface 214 may be used to provide sensor data from the one or more sensors 212 to an autonomous driving system 260 and/or a remote pilot terminal 240. In addition, the communication interface 214 may facilitate communication with the predictive system 250 and the navigation system 220. As such the communication interface 214 may include any appropriate communication interface including local communication busses or networking components. In the later regard, the communication interface 214 may include wide area network connectivity using a cellular network.

The vehicle 210 may also include an autonomous driving system 260. The autonomous driving system 260 may receive sensor data from the one or more sensors 212 to provide autonomous control of the vehicle 210. In this regard, the autonomous driving system 260 may include local processing with instructions that provide for control operations in response to the environment of the vehicle 210 perceived by the one or more sensors 212. In this regard, the autonomous driving system 260 may include logic to provide control of the vehicle 210. However, as may be appreciated, such autonomous driving system 260 may require pre-mapped roadways or other input to provide instructions. Furthermore, some circumstances may present difficulty to the autonomous driving system 260 to provide control of the vehicle 210. For example, highly congested areas with many other vehicles, areas with high volume pedestrian traffic, irregular intersections, or other complex situations (e.g., unprotected left turns, etc.) may result in the autonomous driving system 260 not having sufficient capability to provide control of the vehicle 210.

In this regard, the predictive system 250 may coordinate with the navigation system 220 to predict such areas in which the autonomous driving system 260 may not be capable of autonomous control of the vehicle 210. Specifically, as shown in FIG. 2, the navigation system 220 may allow for a route 256 to be determined for navigation of the vehicle 210 from a present location 254 to a destination (not shown in the map 252 in FIG. 2). The route 256 may be generated upon receipt of a destination from a user to which the vehicle 210 is traveling or from an occupant of the vehicle 210. In this regard, the navigation system 220 may be operative to receive a destination for the vehicle 210 from on-board the vehicle or from a remote location such as an application server 130 of the system 100 or the like.

In any regard, once the route 256 is determined by the navigation system 220, the predictive system 250 may analyze the route 256 to identify one or more suspect areas 258 in which the autonomous driving system 260 may not be capable of autonomous control of the vehicle 210. To do so, the predictive system 250 may access a data repository 230 comprising a plurality of suspect areas corresponding to predetermined locations comprising conditions causing the autonomous control of the vehicle to be compromised. The suspect areas may be added to the autonomous driving system 260 manually by a user by recognition of suspect areas. Additionally or alternatively, suspect areas may be stored in the autonomous driving system 260 in response to an autonomous driving system 260 encountering a problem area such as from another vehicle 210. In this regard, a fleet of vehicle 210 may report instances in which an autonomous driving system 260 encounters a problem that reduces the ability of the autonomous driving system 260 to control the vehicle. Moreover, a vehicle 210 or remote pilot terminal 240 may be operative to flag suspect areas for inclusion in the data repository 230. For instance, if a remote pilot 242 is operating a vehicle 210 and encounters a new potentially problematic condition (e.g., new construction, a reconfiguration of traffic flow, or other newly presented obstacle), the remote pilot 242 and/or operator of the vehicle 210 may flag the area to be included in the data repository 230 as a suspect area by a vehicle having previously passed through a suspect area.

In further examples, suspect areas may be identified automatically based on identifiable conditions that are determined to correspond to suspect areas. For instance, predetermined infrastructure complications may be automatically evaluated to determine a suspect area. Such predetermined infrastructure complications may include at least one of a high congestion area in which many other vehicles are present, a pedestrian area in which a large number of pedestrians are present, an irregular intersection, an infrastructure deficiency (e.g., lack of lane lines or the like), or a complex trajectory challenge (e.g., an unprotected left turn, roundabouts, or complex highway interchanges). In this regard, predetermined infrastructure complications may include those automatically identified from application of logic to maps or the like. Additionally or alternatively, such predetermined infrastructure complications may be manually flagged by a local or remote operator of a vehicle as noted above.

In any regard, a one or more suspect areas 258 may be identified along the route 256 by the predictive system 250 referencing the data repository 230. The predictive system 250 may monitor the progress of the vehicle 210 by interfacing with the navigation system 220, which may include a location module local to the vehicle 210 (e.g., a GPS module or the like). In turn, the predictive system 250 may, ahead of the vehicle 210 encountering the one or more suspect areas 258, schedule a remote pilot 242 at a remote pilot terminal 240 to be assigned to the vehicle 210. Once the remote pilot 242 is assigned to the vehicle 210, the remote pilot 242 may receive sensor data from the one or more sensors 212 at the remote pilot terminal 240. The remote pilot 242 may receive the sensor data ahead of the one or more suspect areas 258. This may allow the remote pilot 242 to become oriented to the vehicle 210 ahead of any potential intervention in controlling the vehicle 210.

As the remote pilot 242 may be connected to the vehicle 210 ahead of the vehicle 210 encountering the one or more suspect areas 258, the remote pilot 242 may initially monitor operation of the autonomous driving system 260. For example, the autonomous driving system 260 may generate projected operations that are to be conducted ahead of the operation actually occurring. For instance, the autonomous driving system 260 may generate trajectory information regarding the path of the vehicle 210. This trajectory information or other operations projected by the autonomous driving system 260 may be provided to the remote pilot 242. The remote pilot 242 may monitor such information for appropriateness given the judgment of the remote pilot 242. In this regard, as the vehicle 210 approaches the one or more suspect areas 258, the remote pilot 242 may simply monitor the projected operations of the autonomous driving system 260 to determine if the autonomous driving system 260 can successfully and safely navigate the one or more suspect areas 258. If the autonomous driving system 260 can successfully navigate the one or more suspect areas 258, the remote pilot 242 may simply monitor the operation of the vehicle 210 by the autonomous driving system 260. Once the vehicle 210 exits the one or more suspect areas 258, autonomous operation of the vehicle 210 by the autonomous driving system 260 may resume. Thus, the one or more suspect areas 258 may correspond to an area of suspected difficulty of the autonomous driving system 260 to control the vehicle 210. However, the autonomous driving system 260 may still be able to successfully navigate the one or more suspect areas 258. In this regard, monitoring of the autonomous driving system 260 by the remote pilot 242 may not result in the remote pilot 242 intervening in control of the vehicle 210. Moreover, the one or more suspect areas 258 may be removed from the data repository 230 if it is determined that the autonomous driving system 260 is capable of reliably navigating the one or more suspect areas 258 (e.g., after a predetermined number of successful navigations of the one or more suspect areas 258 or upon achieving a sufficient confidence level of the autonomous driving system 260 relative to a given one or more suspect areas 258).

In contrast, if the remote pilot 242 determines that an intervention over control of the vehicle 210 should occur, the remote pilot 242 may take over control of the vehicle 210. This may be ahead of the one or more suspect areas 258 or while the vehicle 210 is navigating the one or more suspect areas 258 (e.g., in response to the autonomous driving system 260 providing a projected operation that the remote pilot 242 deems not to be appropriate). In this regard, the remote pilot 242 may intervene to initiate control of the vehicle 210 to provide for remote control of the vehicle 210 by the remote pilot 242. The remote pilot 242 may thus issue commands to control the vehicle 210 via a remote pilot interface 244, which may be effectuated at the vehicle 210. Once the vehicle 210 exits the one or more suspect areas 258 or the remote pilot 242 determines the autonomous driving system 260 is capable of resuming control of the vehicle 210, control of the vehicle 210 may pass back to the autonomous driving system 260. This may be initiated by the remote pilot 242 or the predictive system 250. The remote pilot 242 may continue to monitor operation of the autonomous driving system 260 (e.g., even after exiting the one or more suspect areas 258). Once the control of the vehicle 210 is passed back to the autonomous driving system 260, the remote pilot 242 may be eligible for reassignment to another vehicle 210.

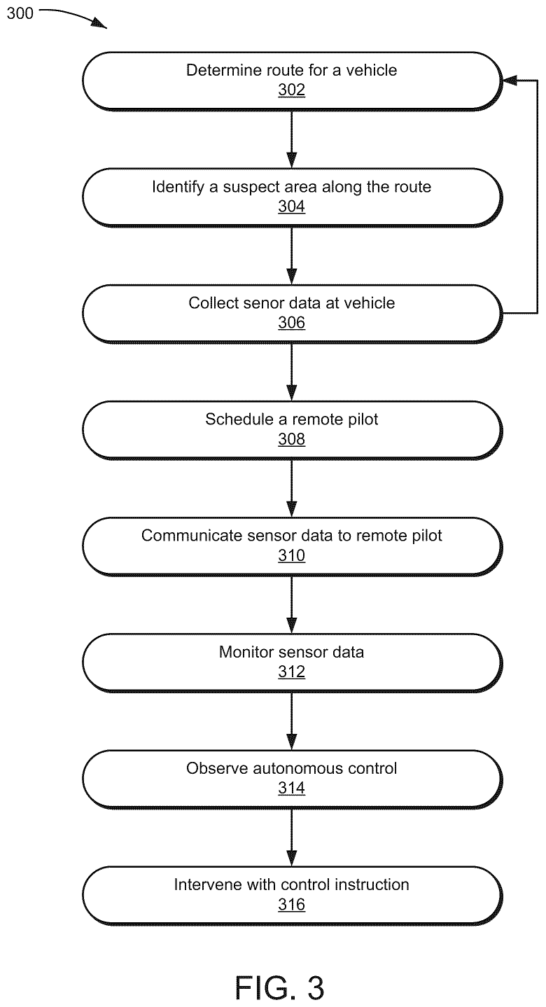

FIG. 3 illustrates an example method 300 for predictive switching between autonomous and remote control of a vehicle. The method 300 may include a determining operation 302 in which a route for a vehicle is determined by a navigation system. The route may be determined in response to entry of a destination to the navigation system. The route may correspond to a planned route of travel that may also be provided to the autonomous driving system to follow. In addition, the route of planned travel may be provided to the vehicle for display locally. The destination may be provided remotely or may be entered locally at the vehicle. In any regard, the method 300 may also include an identifying operation 304 in which a suspect area along the route is identified. As described above, the identifying operation 304 may include comparing the route to a data repository containing known suspect areas to identify in any suspect areas occur along the route. In addition, a plurality of suspect areas along the route may be identified such that the method 300 may be performed for each of the identified suspect areas along the route.

The method 300 may also include a data collecting operation 306 in which sensor data is collected at the vehicle. As noted above, the collecting operation 306 may include collecting sensor data that is provided to an autonomous driving system capable of autonomous control the vehicle. In addition, the data collecting operation 306 may include collecting sensor data that may be useful for a remote pilot to operate the vehicle remotely.

Further still, the collecting operation 306 may include collecting sensor data to monitor the vehicle position using a location module such as a GPS module or the like. In this regard, the method 300 may be iterative such that the data collecting operation 306 may determine whether the vehicle has maintained the route determined in the determining operation 302. Specifically, the method 300 may include detecting that the vehicle has diverged from the route. In turn, the method 300 may iterate to recalculate an alternative route in the determining operation 302 based on detecting the vehicle has diverged from the original route. That is, if the vehicle deviates from the route determined at the determining operation 302, the method 300 may iterate such that a new route is recalculated or redetermined in a determining operation 302 in response to the deviation from the original route. That is, the method 300 may continually iterate such that if the vehicle deviates from a determined route, a new route may be calculated such that suspect areas may be identified in any new route in an identifying operation 304.

The method 300 may also include a scheduling operation 308 in which a remote pilot is scheduled for assignments to the vehicle. Specifically, the scheduling of the remote pilot may include assigning a remote pilot to the vehicle ahead of the vehicle encountering any suspect area along the route. The remote pilot may be assigned ahead of the vehicle encountering the suspect area such that the remote pilot may connect to the vehicle, perform any system checks, and otherwise become oriented to the situation of the vehicle ahead of any control or intervention of operation of the vehicle. In this regard, the method 300 may include a communicating operation 310 in which sensor data is communicated to the remote pilot. The communicating operation 310 may be performed ahead of the vehicle encountering a suspect area such that the remote pilot may become familiar with the vehicle's condition, trajectory, or other information prior to assuming control of the vehicle.

The scheduling operation 308 may include logic to determine when to assign a remote pilot to a vehicle. For example, the scheduling operation 308 may include determining an estimated time of arrival of the vehicle to the suspect area such that the assignment of the remote pilot may occur prior to the vehicle encountering the suspect area. The assignment of the remote pilot may be determined by a predetermined offset ahead of the vehicle encountering the suspect area. The predetermined offset may be a time-based offset or may be a distance based offset. In this regard, it may be appreciated that the speed at which the vehicle is approaching the suspect area may at least in part determine the offset value of when in advance of the suspect area the remote pilot is assigned to the vehicle.

The method 300 may include a monitoring operation 312 in which the remote pilot may monitor the sensor data received from the vehicle without taking control of the vehicle. In this regard, the monitoring operation 312 may be supplemented with an observing operation 314 that may include presenting to the remote pilot projected actions to be taken by an autonomous driving system such that the remote pilot may observe and evaluate the projected operations of the autonomous driving system for appropriateness. The observing operation 314 may continue as the vehicle enters a suspect area while the remote pilot continues to observe the projected operations by the autonomous driving system to determine appropriateness. As such, in at least some scenarios, the remote pilot may simply observe the actions of the autonomous driving system in the observing operation 314.

However, should the remote pilot decide to intervene (e.g., at the remote pilot's discretion, in response to an autonomous driving system projected operation that the remote pilot deems to be inappropriate, or in response to the autonomous driving system deactivating in response to an unresolvable situation) an intervening operation 316 may be performed in which the remote pilot intervenes to assume control of the vehicle. In this regard, the remote pilot may assume full control of the vehicle such that the remote pilot controls the operation of the vehicle without any intervention of the autonomous writing system. In other examples, the autonomous driving system may maintain some control of the vehicle. For example, a vehicle may be traveling on a highway and the remote pilot may intervene to assume control of the steering of the vehicle, while allowing the autonomous driving system to continue to maintain speed and following distance to other vehicles on the highway. In this regard, the intervening operation 316 need not require the remote pilot to assume full control of the vehicle. While not depicted in FIG. 3, the method 300 may further include confirming the vehicle has exited the suspect area (e.g., based on feedback from a location module on the vehicle) and resuming control of the vehicle by the autonomous driving system, either at the direction of the remote pilot or upon the vehicle exiting a suspect area such that the autonomous driving system is determined to be capable of controlling the vehicle autonomously without supervision or intervention by remote pilot.

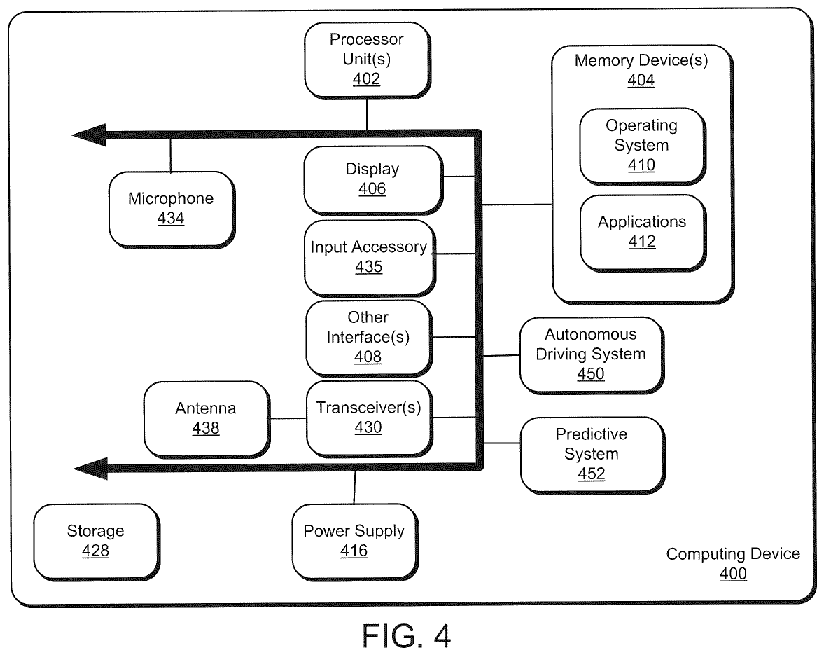

FIG. 4 illustrates an example schematic of a computing device 400 suitable for implementing aspects of the disclosed technology including an autonomous driving system 450 or a predictive system 452 as described above. The computing device 400 includes one or more processor unit(s) 402, memory 404, a display 406, and other interfaces 408 (e.g., buttons). The memory 404 generally includes both volatile memory (e.g., RAM) and non-volatile memory (e.g., flash memory). An operating system 410, such as the Microsoft Windows® operating system, the Apple macOS operating system, or the Linux operating system, resides in the memory 404 and is executed by the processor unit(s) 402, although it should be understood that other operating systems may be employed.

One or more applications 412 are loaded in the memory 404 and executed on the operating system 410 by the processor unit(s) 402. Applications 412 may receive input from various input local devices such as a microphone 434, input accessory 435 (e.g., keypad, mouse, stylus, touchpad, joystick, instrument mounted input, or the like). Additionally, the applications 412 may receive input from one or more remote devices such as remotely located smart devices by communicating with such devices over a wired or wireless network using more communication transceivers 430 and an antenna 438 to provide network connectivity (e.g., a mobile phone network, Wi-Fi®, Bluetooth®). The computing device 400 may also include various other components, such as a positioning system (e.g., a global positioning satellite transceiver), one or more accelerometers, one or more cameras, an audio interface (e.g., the microphone 434, an audio amplifier and speaker and/or audio jack), and storage devices 428. Other configurations may also be employed.

The computing device 400 further includes a power supply 416, which is powered by one or more batteries or other power sources and which provides power to other components of the computing device 400. The power supply 416 may also be connected to an external power source (not shown) that overrides or recharges the built-in batteries or other power sources.

In an example implementation, the computing device 400 comprises hardware and/or software embodied by instructions stored in the memory 404 and/or the storage devices 428 and processed by the processor unit(s) 402. The memory 404 may be the memory of a host device or of an accessory that couples to the host. Additionally or alternatively, the computing device 400 may comprise one or more field programmable gate arrays (FGPAs), application specific integrated circuits (ASIC), or other hardware/software/firmware capable of providing the functionality described herein.

The computing device 400 may include a variety of tangible processor-readable storage media and intangible processor-readable communication signals. Tangible processor-readable storage can be embodied by any available media that can be accessed by the computing device 400 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

In some aspects, the techniques described herein relate to a method for switching between autonomous control and remote control of a vehicle, including: determining a route along which the vehicle is planned to travel; identifying a suspect area of the route, the suspect area including a predetermined location associated with conditions causing the autonomous control of the vehicle to be compromised; collecting sensor data from a sensor on-board the vehicle; scheduling a remote pilot for remote control of the vehicle prior to the vehicle encountering the suspect area; communicating the sensor data from the sensor on-board the vehicle to a remote pilot terminal prior to the vehicle encountering the suspect area; and receiving a control instruction from the remote pilot when the vehicle is within the suspect area.

In some aspects, the techniques described herein relate to a method, wherein the scheduling includes: determining an estimated time of arrival of the vehicle to the suspect area; and assigning the remote pilot to the vehicle according to a predetermined offset ahead of the vehicle encountering the suspect area.

In some aspects, the techniques described herein relate to a method, wherein the predetermined offset relates to at least one of a predetermined time offset or a predetermined distance offset.

In some aspects, the techniques described herein relate to a method, wherein the predetermined offset is at least in part based on vehicle speed.

In some aspects, the techniques described herein relate to a method, further including: confirming the vehicle has passed through the suspect area; and resuming autonomous control of the vehicle in response to the confirming.

In some aspects, the techniques described herein relate to a method, wherein the conditions causing the autonomous control of the vehicle to be compromised include a predetermined infrastructure complication.

In some aspects, the techniques described herein relate to a method, wherein the predetermined infrastructure complication includes at least one of a high congestion area, a pedestrian area, an irregular intersection, an infrastructure deficiency, or a complex trajectory challenge.

In some aspects, the techniques described herein relate to a method, wherein the predetermined infrastructure complication is identified from prior sensor data of another vehicle having passed through the suspect area at a time prior to the identifying a suspect area of the route.

In some aspects, the techniques described herein relate to a method, wherein the predetermined infrastructure complication includes a manually flagged area from a locally operated vehicle having previously passed through the suspect area.

In some aspects, the techniques described herein relate to a method, wherein the determining the route along which the vehicle is planned to travel is in response to a user entering a destination into a navigation system for the vehicle.

In some aspects, the techniques described herein relate to a method, further including: observing the autonomous control of the vehicle by the remote pilot prior to the vehicle entering the suspect area and during autonomous vehicle operation in the suspect area; wherein the control instruction is provided in response to the remote pilot determining an intervention to the autonomous operation is appropriate.

In some aspects, the techniques described herein relate to a method, wherein the remote pilot is provided projected autonomous control operations to observe and allow for the intervention.

In some aspects, the techniques described herein relate to a method, further including: detecting that the vehicle has diverged from the route; recalculating an alternate route based on the detecting; and identifying a second suspect area of the alternate route.

In some aspects, the techniques described herein relate to a system for a vehicle to switching between autonomous control and remote control of the vehicle, including: a navigation system operative to determining a route along which the vehicle is planned to travel; a data repository including a plurality of suspect areas corresponding to predetermined locations including conditions causing the autonomous control of the vehicle to be compromised; a predictive system operative to compare the route to the plurality of suspect areas to identify a suspect area of the route and, in response to identifying the suspect area, schedule a remote pilot for remote control of the vehicle prior to the vehicle encountering the suspect area; at least one sensor on-board the vehicle operative to collect sensor data regarding an environment of the vehicle; and a communication interface operative to communicate the sensor data from the sensor on-board the vehicle to a remote pilot terminal prior to the vehicle encountering the suspect area and receive a control instruction from the remote pilot when the vehicle is within the suspect area.

In some aspects, the techniques described herein relate to a system, wherein the predictive system is operative to determine an estimated time of arrival of the vehicle to the suspect area and assign the remote pilot to the vehicle according to a predetermined offset ahead of the vehicle encountering the suspect area.

In some aspects, the techniques described herein relate to a system, wherein the predetermined offset relates to at least one of a predetermined time offset or a predetermined distance offset.

In some aspects, the techniques described herein relate to a system, wherein the predetermined offset is at least in part based on vehicle speed.

In some aspects, the techniques described herein relate to a system, wherein the predictive system is operative to confirm the vehicle has passed through the suspect area and resume autonomous control of the vehicle in response to the confirming.

In some aspects, the techniques described herein relate to a system, wherein the conditions causing the autonomous control of the vehicle to be compromised include a predetermined infrastructure complication.

In some aspects, the techniques described herein relate to a system, wherein the predetermined infrastructure complication includes at least one of a high congestion area, a pedestrian area, an irregular intersection, an infrastructure deficiency, or a complex trajectory challenge.

In some aspects, the techniques described herein relate to a system, wherein the predetermined infrastructure complication is identified from prior sensor data of another vehicle having passed through the suspect area at a time prior to the identifying a suspect area of the route.

In some aspects, the techniques described herein relate to a system, wherein the predetermined infrastructure complication includes a manually flagged area from a locally operated vehicle having previously passed through the suspect area.

In some aspects, the techniques described herein relate to a system, wherein the navigation system determines the route along which the vehicle is planned to travel based on a user entering a destination.

In some aspects, the techniques described herein relate to a system, wherein the predictive system is operative to allow for observation of the autonomous operation of the vehicle by the remote pilot prior to the vehicle entering the suspect area and during the vehicle operation in the suspect area; wherein the control instruction is provided in response to the remote pilot determining an intervention to the autonomous operation is appropriate.

In some aspects, the techniques described herein relate to a system, wherein the remote pilot is provided projected autonomous control operations to observe and allow for the intervention.

In some aspects, the techniques described herein relate to a system, wherein the predictive system is operative to detect that the vehicle has diverged from the route, recalculate an alternate route based on the detecting, and identifying a second suspect area of the alternate route.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for switching between autonomous control and remote control of a vehicle, comprising:
determining a route along which the vehicle is planned to travel;
identifying a suspect area of the route, the suspect area comprising a predetermined location associated with conditions causing the autonomous control of the vehicle to be compromised;
collecting sensor data from a sensor on-board the vehicle;
scheduling a remote pilot for remote control of the vehicle prior to the vehicle encountering the suspect area;
communicating the sensor data from the sensor on-board the vehicle to a remote pilot terminal prior to the vehicle encountering the suspect area; and
receiving a control instruction from the remote pilot when the vehicle is within the suspect area.

2. The method of claim 1, wherein the scheduling comprises:
determining an estimated time of arrival of the vehicle to the suspect area; and
assigning the remote pilot to the vehicle according to a predetermined offset ahead of the vehicle encountering the suspect area.

3. (canceled)

4. (canceled)

5. The method of claim 1, further comprising:
confirming the vehicle has passed through the suspect area; and
resuming autonomous control of the vehicle in response to the confirming.

6. The method of claim 1, wherein the conditions causing the autonomous control of the vehicle to be compromised comprise a predetermined infrastructure complication.

7. The method of claim 6, wherein the predetermined infrastructure complication comprises at least one of a high congestion area, a pedestrian area, an irregular intersection, an infrastructure deficiency, or a complex trajectory challenge.

8. The method of claim 6, wherein the predetermined infrastructure complication is identified from prior sensor data of another vehicle having passed through the suspect area at a time prior to the identifying a suspect area of the route.

9. The method of claim 6, wherein the predetermined infrastructure complication comprises a manually flagged area from a locally operated vehicle having previously passed through the suspect area.

10. The method of claim 1, wherein the determining the route along which the vehicle is planned to travel is in response to a user entering a destination into a navigation system for the vehicle.

11. The method of claim 1, further comprising:
observing the autonomous control of the vehicle by the remote pilot prior to the vehicle entering the suspect area and during autonomous vehicle operation in the suspect area;
wherein the control instruction is provided in response to the remote pilot determining an intervention to the autonomous operation is appropriate.

12. The method of claim 11, wherein the remote pilot is provided projected autonomous control operations to observe and allow for the intervention.

13. The method of claim 1, further comprising:
detecting that the vehicle has diverged from the route;
recalculating an alternate route based on the detecting; and
identifying a second suspect area of the alternate route.

14. A system for a vehicle to switching between autonomous control and remote control of the vehicle, comprising:
a navigation system operative to determining a route along which the vehicle is planned to travel;
a data repository comprising a plurality of suspect areas corresponding to predetermined locations comprising conditions causing the autonomous control of the vehicle to be compromised;
a predictive system operative to compare the route to the plurality of suspect areas to identify a suspect area of the route and, in response to identifying the suspect area, schedule a remote pilot for remote control of the vehicle prior to the vehicle encountering the suspect area;
at least one sensor on-board the vehicle operative to collect sensor data regarding an environment of the vehicle; and
a communication interface operative to communicate the sensor data from the sensor on-board the vehicle to a remote pilot terminal prior to the vehicle encountering the suspect area and receive a control instruction from the remote pilot when the vehicle is within the suspect area.

15. The system of claim 14, wherein the predictive system is operative to determine an estimated time of arrival of the vehicle to the suspect area and assign the remote pilot to the vehicle according to a predetermined offset ahead of the vehicle encountering the suspect area.

16. (canceled)

17. (canceled)

18. The system of claim 14, wherein the predictive system is operative to confirm the vehicle has passed through the suspect area and resume autonomous control of the vehicle in response to the confirming.

19. The system of claim 14, wherein the conditions causing the autonomous control of the vehicle to be compromised comprise a predetermined infrastructure complication.

20. The system of claim 19, wherein the predetermined infrastructure complication comprises at least one of a high congestion area, a pedestrian area, an irregular intersection, an infrastructure deficiency, or a complex trajectory challenge.

21. (canceled)

22. (canceled)

23. The system of claim 14, wherein the navigation system determines the route along which the vehicle is planned to travel based on a user entering a destination.

24. The system of claim 14, wherein the predictive system is operative to allow for observation of the autonomous operation of the vehicle by the remote pilot prior to the vehicle entering the suspect area and during the vehicle operation in the suspect area;
wherein the control instruction is provided in response to the remote pilot determining an intervention to the autonomous operation is appropriate.

25. The system of claim 24, wherein the remote pilot is provided projected autonomous control operations to observe and allow for the intervention.

26. The system of claim 14, wherein the predictive system is operative to detect that the vehicle has diverged from the route, recalculate an alternate route based on the detecting, and identifying a second suspect area of the alternate route.
